(19) United States
(12) Patent Application Publication
(10) Pub. No.: US 2013/0162693 A1
(43) Pub. Date: Jun. 27, 2013

(54) MULTI-GRAY LEVEL DISPLAY APPARATUS AND METHOD THEREOF

(71) Applicant: Shi-Lin LI, HSINCHU (TW)

(72) Inventor: Shi-Lin LI, HSINCHU (TW)

(73) Assignee: E INK HOLDINGS INC., HSINCHU (TW)

(21) Appl. No.: 13/615,625

(22) Filed: Sep. 14, 2012

(30) Foreign Application Priority Data
Dec. 23, 2011 (TW) 100148329

(51) Int. Cl. G09G 5/10

(52) U.S. Cl. 345/690

(57) ABSTRACT

A display with at least N(P−1)+1 number of gray levels extended from P number of gray levels is disclosed. The display includes a row driver, a column driver, scan lines and data lines crossing the scan lines to form a pixel matrix with pixels. The scan lines couple with the row driver and the data lines couple with the column driver. Each pixel further includes N number of sub-pixels and M number of transistors. The N number of sub-pixels are grouped into M number of sub-pixel groups. The M number of transistors control the M number of sub-pixel groups respectively and each sub-pixel group receives one of the P number of gray levels to display corresponding gray levels.

### RELATED APPLICATIONS

This application claims priority to Taiwan Application Serial Number 100148329, filed Dec. 23, 2011, which is herein incorporated by reference.

### TECHNICAL FIELD

The present disclosure relates to a display apparatus and method thereof, and more particularly to a multi-gray level display apparatus and method thereof.

### BACKGROUND

With rapid development of display techniques, many new display apparatus have been manufactured. Among the newly-developed display apparatus, the electro-phoretic display (EPD) exhibits many promising advantages such as lower energy consumption, longer lifetime, flexible property and more compact size.

FIG. 1 illustrates a schematic diagram of an electro-phoretic display. The electro-phoretic display includes two glass substrates 101 and 102 and an electronic ink layer 103 located between the two glass substrates 101 and 102. A common electrode is formed over the glass substrate 101. A plurality of electrode is formed on the glass substrate 102. The glass substrates 101 and 102 can be replaced with plastic substrates. The electronic ink layer 103 includes a plurality of microcapsules whose diameter is about 50 to 70 micrometers. Each microcapsule includes black particles 108 and white particles 109. When the electrodes in the glass substrate 102 change in electrical polarity, the black particles 108 and white particles 109 can move up and down based on the positive polarity or negative polarity of the electrode, so as to display a black image or white image in the visual side. For example, the black particles 108 are positive-electrically charged and the white particles 109 are negative-electrically charged. When an electrode in the glass substrate 102 is negatively biased as a negative electrode, the positive-electrically charged black particles 108 are attracted and the negative-electrically charged white particles 109 are repulsed. As a result, the white particles 109 are arranged in the visual side of the electro-phoretic display showing white color. When the applied electric field is removed, the electro-phoretic display keeps displaying the original image, such that the electro-phoretic display exhibits a bistable characteristic.

However, it is very difficult to precisely control and track the positions of the black particles and white particles in microcapsules. Therefore, typically the electro-phoretic display only displays two gray-level colors: one is the white particles being arranged in the visual side to display completely white color and another is the black particles being arranged in the visual side to display completely black color. For a display only for texts, it is enough for the electro-phoretic display to use black and white gray levels. However, for a display for multi-level image, it is insufficient for the electro-phoretic display to only use two gray levels. Therefore, there is a need to extend the number of the gray levels for the electro-phoretic display.

### SUMMARY

The present disclosure provides a pixel structure and method to increase the number of the gray levels. The method is to mix the original gray-level colors to get additional gray-level colors.

In an embodiment of the present disclosure discloses a display. P number of gray levels are extended to at least N(P−1)+1 number of gray levels in the display. The display includes a row driver, a column driver, scan lines and data lines. The scan lines couple with the row driver and are arranged in a row direction. The data lines couple with the column driver and are arranged in a column direction. The scan lines cross the data lines to form a pixel matrix having pixels. Each pixel further includes N number of sub-pixels and M number of transistors. The N number of sub-pixels are grouped into M number of sub-pixel groups. Each sub-pixel group has at least one of the sub-pixels. Both the N number and the M number are integers larger than 1. The M number of transistors respectively couple with one of the scan lines and M number of the data lines. The M number of transistors respectively control the M number of sub-pixel groups to display corresponding gray levels.

In an embodiment, the display is an electro-phoretic display, a reflective-type display or a bistable-state display.

In an embodiment, the column driver applies P number of gray-level voltages, and the P number is an integer larger than 1.

In an embodiment, the N number is four and the M number is three. The respective three sub-pixel groups have one sub-pixel, one sub-pixel and two sub-pixels. Under control of the three transistors one of the P number of gray-level voltages is applied to the respective three sub-pixel groups through three of the data lines.

In an embodiment, the N number is nine and the M number is four. The respective four sub-pixel groups have one sub-pixel, two sub-pixels, two sub-pixels and four sub-pixels. Under control of the four transistors one of the P number of gray-level voltage is applied to the respective four sub-pixel groups through four of the data lines.

The present disclosure provides a method for extending P number of gray levels to at least N(P−1)+1 number of gray levels in a display. The display includes a row driver, a column driver, data lines and scan lines. The column driver applies P number of gray-level voltages and the P number is an integer larger than 1. The method includes forming a pixel matrix is defined by the scan lines crossing the data lines, and has a plurality of pixel. Each of the pixels is divided into N number of sub-pixels, and the N number of sub-pixels are grouped into M number of sub-pixel groups, in which each of the sub-pixel groups has at least one sub-pixel, wherein both the N number and the M number are integers larger than 1. M number of transistors are formed to respectively control the M number of sub-pixel groups, wherein the M number of transistors couple with one of the scan lines and respectively couple with M number of the data lines, and under control of the M number of transistors one of the P number of gray-level voltages is applied to the respective M number of sub-pixel groups through the M number of data lines.

Accordingly, by re-designing the pixel, the number of the gray levels can be extended to a number of gray levels larger than the number of gray levels in a conventional display.

### BRIEF DESCRIPTION OF THE DRAWINGS

In order to make the foregoing as well as other aspects, features, advantages, and embodiments of the present disclosure more apparent, the accompanying drawings are described as follows:

FIG. 1 illustrates a schematic diagram of a typical electro-phonetic display.

FIG. 2 illustrates a schematic diagram of an equivalent circuit of a multi-gray level display apparatus according to an embodiment of the present disclosure.

FIG. 3 illustrates a schematic diagram of a pixel of a multi-gray level display apparatus according to an embodiment of the present disclosure.

FIG. 4A to FIG. 4E illustrate schematic diagrams explaining how to generate additional gray-level colors.

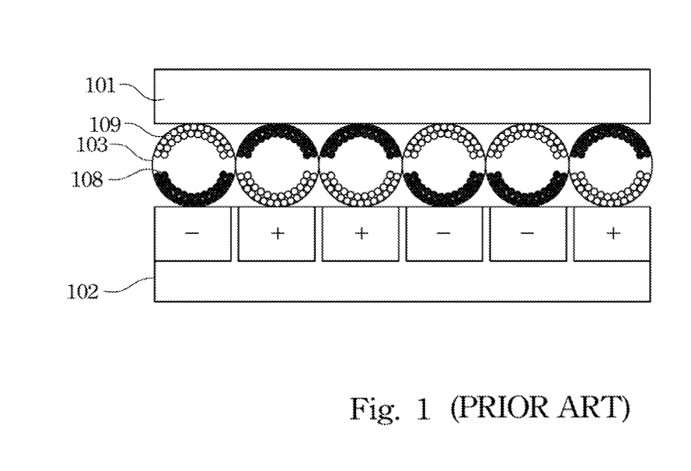

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In an embodiment of the present disclosure method is to mix the original gray levels generated by a display apparatus to get additional gray levels. According to this method, a pixel is divided into sub-pixels. Each sub-pixel displays original gray-level color. These gray levels generated by sub-pixels in a pixel are mixed to generate another gray-level color different from the original gray-level color. The display apparatus is an electro-phoretic display, a reflective-type display or a display with a bistable characteristic.

In an embodiment, a display generates P number of gray levels. When the P number of gray levels are enlarged to at least N(P−1)+1 number of gray levels, each pixel of the display is divided into N number of sub-pixels. The N number of sub-pixels are grouped into M number of sub-pixel groups. Each sub-pixel group has at least one sub-pixel. Each number of 1-N is got by adding the number of sub-pixels in some of these sub-pixel groups. All the P number, N number and M number are integers larger than 1. In each sub-pixel group, a transistor controls the connection between this sub-pixel group and a corresponding data line and this sub-pixel group and a scan line. In other words, in a pixel, the M number of sub-pixel groups are controlled through a single scan line to respectively apply the grey-level voltage through M number of the data lines to each pixel in a corresponding pixel group. As an embodiment, an electro-phoretic display two gray levels is extended to five gray levels according to the present disclosure.

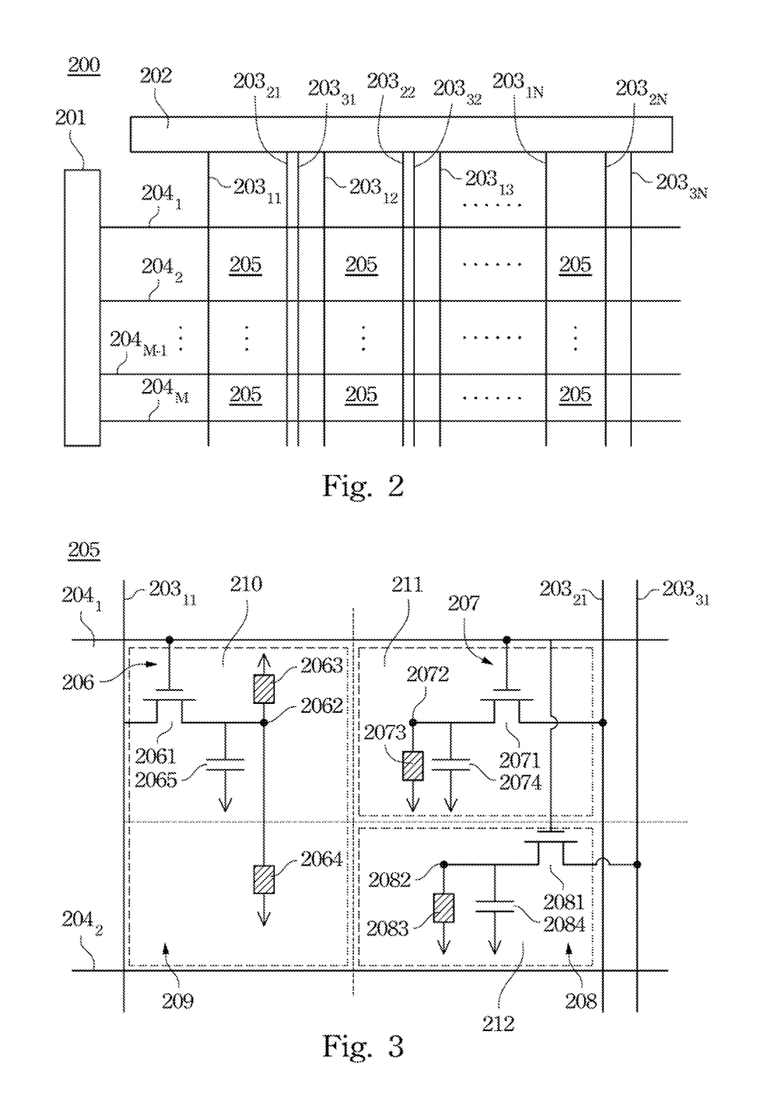

FIG. 2 illustrates a schematic diagram of an equivalent circuit of a multi-gray level electro-phoretic display apparatus according to an embodiment of the present disclosure. In this embodiment, each pixel of the electro-phoretic display is divided into four sub-pixels. The four sub-pixels are grouped into three sub-pixel groups, a first sub-pixel group, a second sub-pixel group and a third sub-pixel group. The first sub-pixel group has one sub-pixel. The second sub-pixel group has one sub-pixel. The third sub-pixel group has two sub-pixels.

Each number of 1-4 is got by adding the sub-pixel number, one, one and two. In each sub-pixel group, a transistor controls the connection between this sub-pixel group and a corresponding data line and this sub-pixel group and a scan line. Therefore, each pixel has three transistors.

Accordingly, this electro-phoretic display apparatus 200 includes a row driver 201, a column driver 202, scan lines 204₁-204_{M}, first data lines 203₁₁-203_{1N}, second data lines 203₂₁˜203_{2N}, and third data lines 203₃₁-203_{3N}. The scan lines 204₁-204_{M} are arranged in a row direction and parallel to each other. The first data lines 203₁₁-203_{1N} the second data lines 203₂₁-203_{2N}, and the third data lines 203₃₁-203_{3N} are sequentially arranged in a column direction and parallel to each other. The scan lines 204₁-204_{M} are connected to the row driver 201. The first data lines 203₁₁-203_{1N}, the second data lines 203₂₁-203_{2N}, and the third data lines 203₃₁-203_{3N} are connected to the column driver 202. The scan lines 204₁-204_{M} cross the first data lines 203₁.₁-203_{1N}, the second data lines 203₂₁-203_{2N}, and the third data lines 203₃₁-203_{3N} to form a pixel matrix 205.

FIG. 3 illustrates a schematic diagram of a pixel of a multi-gray level display apparatus according to an embodiment of the present disclosure. A pixel 205 is defined by scan lines 204₁ and 204₂ and the first data line 203₁₁, the second data line 203₂₁, and the third data line 203₃₁. The pixel 205 is divided into four sub-pixels, the first sub-pixel 206, the second sub-pixel 207, the third sub-pixel 208 and the fourth sub-pixel 209. The four sub-pixels are grouped into three sub-pixel groups, a first sub-pixel group 210, a second sub-pixel group 211 and a third sub-pixel group 212. The first sub-pixel group 210 has the first sub-pixel 206 and the fourth sub-pixel 209. A transistor 2061 controls the first sub-pixel 206 and the fourth sub-pixel 209. A gate electrode of the transistor 2061 is connected to the scan line 204₁. A source electrode of the transistor 2061 is connected to the first data line 203₁₁. A drain electrode of the transistor 2061 is connected to the pixel electrode 2062. The pixel electrode 2062 and a common electrode form a pixel capacitor 2063 located in the first sub-pixel 206, a pixel capacitor 2064 located in the fourth sub-pixel 209 and a storage capacitor 2065.

The second sub-pixel group 211 has the second sub-pixel 207. A transistor 2071 controls the second sub-pixel 207. A gate electrode of the transistor 2071 is connected to the scan line 204₁. A source electrode of the transistor 2071 is connected to the second data line 203₂. A drain electrode of the transistor 2071 is connected to the pixel electrode 2072. The pixel electrode 2072 and a common electrode form a pixel capacitor 2073 and a storage capacitor 2074.

The third sub-pixel group 212 has the third sub-pixel 208. A transistor 2081 controls the third sub-pixel 208. A gate electrode of the transistor 2081 is connected to the scan line 204₁. A source electrode of the transistor 2081 is connected to the third data line 203₃₁. A drain electrode of the transistor 2081 is connected to the pixel electrode 2082. The pixel electrode 2082 and a common electrode form a pixel capacitor 2083 and a storage capacitor 2084.

When a scan voltage is applied to the scan line 204₁, the transistors 2061 2071 and 2081 are turned on. The gray-level voltage in the first data line 203₁₁ is applied to the pixel electrode 2062 passing the transistor 2061. As such, this gray-level voltage is applied to the pixel capacitors 2063, 2064 and the storage capacitor 2065, so as to provide the pixel electrode 2062 of the first sub-pixel 206 and the fourth sub-pixel 209 with the gray-level voltage in the first data line 203₁₁. Moreover, the gray-level voltage in the second data line 203₂₁ is applied to the pixel electrode 2072 passing the transistor 2071 As such, this gray-level voltage is applied to the pixel capacitors 2073 and the storage capacitor 2074 connected to the pixel electrode 2072, so as to provide the pixel electrode 2072 of the second sub-pixel 207 with the gray-level voltage in the second data line 203₂₁. On the other hand, the gray-level voltage in the third data line 203₃₁ is applied to the pixel electrode 2082 passing the transistor 2081, As such, this gray-level voltage is applied to the pixel capacitors 2083 and the storage capacitor 2084, so as to provide the pixel electrode 2082 of the third o sub-pixel 208 with the gray-level voltage in the third data line 203₃₁. By the various gray-level voltages applied to the pixel electrodes 2062, 2072 and 2082 through the first data line 203₁₁, the second data line 203₂₁ and the third data line 203₃₁, the number of gray levels is extended by optical synthesis.

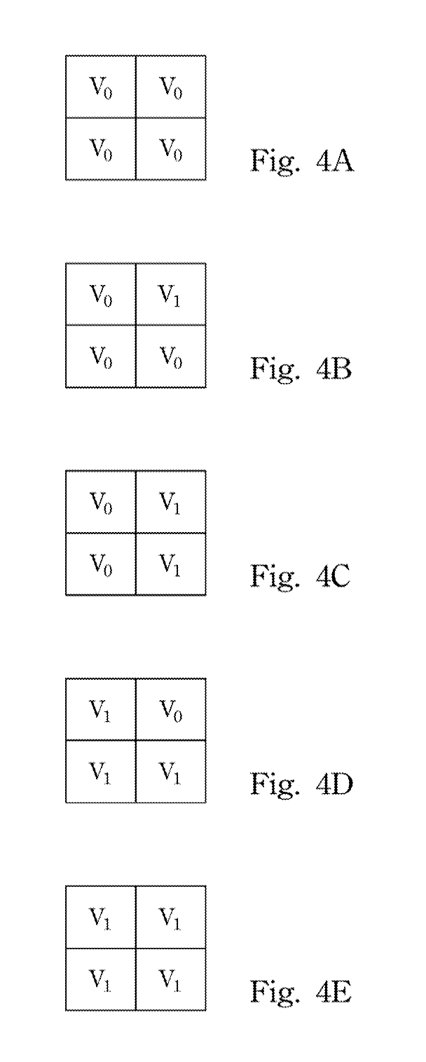

FIG. 4A to FIG. 4E illustrate schematic diagrams to explain how to generate new gray levels according to an embodiment of the present disclosure. Each pixel includes four sub-pixels. The gray-level voltage V₀ means the white particles are arranged in the visual side to display white color. The gray-level voltage V₁ means the black particles are arranged in the visual side to display black color.

Accordingly, as shown in FIG. 4A, when the gray-level voltage V₀ is applied to the first sub-pixel 206, the second sub-pixel 207, the third sub-pixel 208 and the fourth sub-pixel 209 through the first data line 203₁₁, the second data line 203₂₁, and the third data line 203₃₁ respectively, only the white particles are arranged in the visual side. Therefore, the pixel 205 displays a first gray level, white color.

In FIG. 4B, when the gray-level voltage V₀ is applied to the first sub-pixel 206, the third sub-pixel 208 and the fourth sub-pixel 209 through the first data line 203₁₁ and the third data line 203₃₁ respectively and the gray-level voltage V₁ is applied to the second sub-pixel 207 through the second data line 203₂₁, the white particles are arranged in the visual side in the first sub-pixel 206, the third sub-pixel 208 and the fourth sub-pixel 209 and the black particles are arranged in the visual side in the second sub-pixel 207. Therefore, the pixel 205 displays a second gray level, (white color+white color+white color+black color)/4, which is darker than the first gray level.

In FIG. 4C, when the gray-level voltage V₀ is applied to the first sub-pixel 206 and the fourth sub-pixel 209 through the first data line 203₁₁, and the gray-level voltage V₁ is applied to the second sub-pixel 207 and the third sub-pixel 208 through the second data line 203₂₁ and the third data line 203₃₁ respectively, the white particles are arranged in the visual side in the first sub-pixel 206 and the fourth sub-pixel 209 and the black particles are arranged in the visual side in the second sub-pixel 207 and the third sub-pixel 208. Therefore, the pixel 205 displays a third gray level, (white color+white color+black color+black color)/4, which is darker than the second gray level.

In FIG. 4D, when the gray-level voltage V₁ is applied to the first sub-pixel 206, the third sub-pixel 208 and the fourth sub-pixel 209 through the first data line 203₁₁ and the third data line 203₃₁ respectively and the gray-level voltage V₀ is applied to the second sub-pixel 207 through the second data line 203₂₁, the black particles are arranged in the visual side in the first sub-pixel 206, the third sub-pixel 208 and the fourth sub-pixel 209 and the white particles are arranged in the visual side in the second sub-pixel 207. Therefore, the pixel 205 displays a fourth gray level, (black color+black color+black color+white color)/4, which is darker than the third gray level.

In FIG. 4E, when the gray-level voltage V₁ is applied to the first sub-pixel 206, the second sub-pixel 207, the third sub-pixel 208 and the fourth sub-pixel 209 through the first data line 203₁₁, the second data line 203₂₁, and the third data line 203₃₁ respectively, only the black particles are arranged in the visual side. Therefore, the pixel 205 displays a fifth gray level, black color.

Accordingly, in this above embodiment, the number of the gray levels is enlarged from two levels to five levels by redesigning the pixel. That is, three additional gray levels, a second gray level (white color+white color+white color+black color)/4, a third gray level (white color+white color+black color+black color)/4 and a fourth gray level (black color+black color+black color+white color)/4, are generated other than the original two gray levels, white and black. Therefore, a better display quality is achieved. It is noticed that, the number of the gray levels also can be enlarged from two levels to other number larger than two of levels.

For example, in another embodiment, a display generates eight gray levels. When the eight gray levels are enlarged to sixty-four gray levels, each pixel of the display is divided into nine sub-pixels. The nine sub-pixels are grouped into four sub-pixel groups, a first sub-pixel group, a second sub-pixel group, a third sub-pixel group and a fourth sub-pixel group. The first sub-pixel group has one sub-pixel. The second sub-pixel group has two sub-pixels. The third sub-pixel group has two sub-pixels. The fourth sub-pixel group has four sub-pixels. Each number of 1-9 is got by adding the sub-pixel number, one, two, two and fourth. In each sub-pixel group, a transistor controls the connection between this sub-pixel group and a corresponding data line and this sub-pixel group and a scan line. Therefore, in this embodiment, each pixel has four transistors, four data lines and one scan line.

Accordingly, by re-designing the pixel, the number of the gray levels can be extended to a number of gray levels larger than the original number of gray levels in the conventional display.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display, applicable to extending P number of gray levels o at least N(P−1)+1 number of gray levels, comprising:
a row driver;
a column driver;
plurality of scan lines coupling with the row driver and arranged in a row direction; and
a plurality of data lines coupling with the column driver and arranged in a column direction, wherein the scan lines cross the data lines to form a pixel matrix having a plurality of pixels, each of the pixels further comprising:
N number of sub-pixels, wherein the N number of sub-pixels are grouped into M number of sub-pixel groups, each of the sub-pixel groups has at least one of the sub-pixel, wherein the N number and the M number are integers larger than 1; and
M number of transistors respectively coupling with one of the scan lines and M number of the data lines, wherein the M number of transistors respectively control the M number of sub-pixel groups to display corresponding gray levels.

2. The display of claim 1, wherein the display is an electro-phoretic display, a reflective-type display or a bistable-state display.

3. The display of claim 1, wherein the column driver applies P number of gray-level voltages, and the P number is an integer larger than 1.

4. The display of claim 1, wherein the N number is four and the M number is three, and the respective three sub-pixel groups have one of the sub-pixels, one of the sub-pixels and two of the sub-pixels, in which under control of the three transistors one of the P number of gray-level voltages is applied to the respective three sub-pixel groups through three of the data lines.

5. The display of claim 1, wherein the N number is nine and the M number is four, and the respective four sub-pixel groups have one of the sub-pixels, two of the sub-pixels, two of the sub-pixels and four of the sub-pixels, in which under control of the four transistors one of the P number of gray-level voltages is applied to the respective sub-pixel groups through four of the data

6. A method for extending P number of gray levels to at least N(P−1)+1 number of gray levels in a display, the display comprises a row driver, a column driver applying P number of gray-level voltages and the P number being an integer larger than 1, a plurality of data lines and a plurality of scan lines, the method comprising the steps of.
forming a pixel matrix defined by the scan lines crossing the data lines, and having a plurality of pixels;
dividing each of the pixels into N number of sub-pixels;
grouping the N number of sub-pixels into M number of sub-pixel groups, each of the sub-pixel groups having at least one of the sub-pixels, and the N number and the M number being integers larger than 1; and
forming M number of transistors to respectively control the M number of sub-pixel groups, wherein the M number of transistors couple with one of the scan lines and respectively couple with M number of the data lines, and under control of the M number of transistors one of the P number of gray-level voltages is applied to the respective M number of sub-pixel groups through the M number of data lines.

7. The method of claim 6, wherein the display is an electro-phoretic display, a reflective-type display or a bistable-state display.

8. The method of claim 6, wherein the N number is four and the M number is three, and the respective three sub-pixel groups have one of the sub-pixels, one of the sub-pixels and two of the sub-pixels, in which under control of the three transistors one of the P number of gray-level voltages is applied to the respective three sub-pixel groups through three of the data lines.

9. The method of claim 6, wherein the N number is nine and the M number is four, and the respective four sub-pixel groups have one of the sub-pixels, two of the sub-pixels, two of the sub-pixels and four of the sub-pixels, in which under control of the four transistors one of the P number of gray-level voltages is applied to the respective four sub-pixel groups through four of the data lines.
